(19) United States
(12) Patent Application Publication
(10) Pub. No.: US 2006/0173680 A1
(43) Pub. Date: Aug. 3, 2006

(54) Partial spelling in speech recognition

(76) Inventors: Jan Verhasselt, Erpe-Merg (BE); Rudi Vuerinckx, Brussel (BE); Brigitte Giese, Aachen (DE)

Correspondence Address: BROMBERG & SUNSTEIN LLP, 125 SUMMER STREET, BOSTON, MA, 02110-1618, US

(21) Appl. No.: 11/331,432

(22) Filed: Jan. 12, 2006

Related U.S. Application Data
(60) Provisional application No. 60/643,252, filed on Jan. 12, 2005.

(51) Int. Cl. G10L 15/26

(52) U.S. Cl. 704/235

(57) ABSTRACT

A method of speech recognition processing is described based on spelling out the initial characters of a word or a sequence of words. Characters representative of an initial portion of an intended user input are collected from a user. In response to a first user action, (e.g., a short pause) at least one name matching hypothesis is provided to the user which is predicted to correspond to the intended user input. Then, in response to a second user action, one name matching hypothesis is selected as representing the intended user input.

This application claims priority from U.S. Provisional Patent Application 60/643,252, filed Jan. 12, 2005, the contents of which are incorporated herein by reference.

### FIELD OF THE INVENTION

The invention relates to automatic speech recognition and specifically to the recognition of names and words by means of partial spelling.

### BACKGROUND ART

Operation of a typical speech recognition engine according to the prior art is illustrated in FIG. 1. A speech signal 10 is directed to a pre-processor 11, where relevant parameters are extracted. A pattern matching recognizer 12 tries to find the best word sequence recognition result 15 based on acoustic models 13 and a language model 14. The language model 14 describes words and how they connect to form a sentence. The acoustic models 13 establish a link between the speech parameters from the pre-processor 11 and the recognition symbols that need to be recognized. Further information on the design of a speech recognition system is provided, for example, in Rabiner and Juang, Fundamentals of Speech Recognition (hereinafter “Rabiner and Juang”), Prentice Hall 1993, which is hereby incorporated herein by reference.

More formally, speech recognition systems typically operate by determining a word sequence, Ŵ that maximizes the following equation:

$$\hat{W} = arg {max}_{W} P ( W ) P ( A \vert W )$$

where A is the input acoustic signal, W is a given word string consisting of one or more words, P(W) is the probability that the word sequence W will be uttered, and P(A|W) is the probability of the acoustic signal A being observed when the word string W is uttered. The acoustic model characterizes P(A|W), and the language model characterizes P(W).

Rather than directly recognizing the spoken word sequences, speech recognition applications may also recognize the word sequences when the input is a spelled out sequence of characters (letters, digits, special characters) that together form the word sequences, or part of them. This can be done in one step by means of a language model that has a non-zero probability P(W) for the character sequences that correspond with the word sequences (or part of them) only. But often two steps are used: (1) let the recognition engine produce a character recognition result, and (2) find the word sequence that best matches with the recognized character result.

This two-step spelling approach is illustrated in FIG. 2, where a recognition language model 20 has a non-zero probability for more character sequences than those that correspond with the word sequences (or part of them) that can be recognized. For example, the recognition language model 20 can allow any sequence of one or more characters. A name list 23 enumerates the word sequences that can be recognized. This can be a list of names like person names, city names or street names, but can in general be any list of sequences of one or more words. In the remainder of this document, we refer to these sequences of words for simplicity as names, without reducing the generality. The name list 23 can be as simple as a text file with a list of names, or a compiled binary representation of that list. A spelling matcher module 22 identifies the name from the list that best matches the recognized character result. This result can be as simple as the most likely sequence of recognized characters, but can also be a character lattice, an N-best list of character sequences, a sequence of N-best lists of characters, or other representations of the result of the recognition engine.

Rather than a single best recognition result, speech recognition applications may also give feedback to users by displaying or prompting a sorted list of some number of the best matching recognition hypotheses, referred to as an N-best list. This can be done for recognition of a spoken utterance as one or more words. This can also be done when the input is a spelled out sequence of characters forming a name or part of a name, in which case a spelling-matching module may identify the N-best list of best matching names.

It is also known to offer the user the possibility to continue spelling after a first name matching result has been presented to him. Typically, an incremental partial spelling user interface allows the user to spell out a number of characters one after the other without long pauses between the characters. When the user issues a stop spelling-command (e.g. the word “stop”), or when he makes a long pause, an N-best list of best matching names is presented by means of speech output (sometimes only the best matching name is outputted audibly, but the N-best list can be shown on screen at the same time). The user may be further offered the choice to continue spelling, which will generate a new N-best list of best matching names that is presented after a subsequent stop spelling-command or when the user makes a long pause after spelling some characters.

### SUMMARY OF THE INVENTION

Embodiments of the present invention are directed to techniques for partial spelling of inputs in automatic speech recognition. Characters representative of an initial portion of an intended user input are collected from the user. In response to a first user action, which can be a short pause, the user is visually provided with at least one name matching hypothesis predicted to correspond to the intended user input. However, the recognition engine keeps listening to the speech signal. Then, in response to a second user action, which can be a longer pause, one of the recognition hypotheses is selected as representing the intended user input.

Embodiments also are directed to techniques for partial spelling of inputs in automatic speech recognition which include collecting from a user characters representative of an initial portion of an intended user input; and in response to a first user action, providing to the user at least one name matching hypothesis predicted to correspond to the intended user input, where such hypothesis can be a prefix common to multiple names. The at least one name matching hypothesis may be provided visually and/or audibly to the user. Such common prefix doesn't necessarily consist of the actual characters that have been spelled out so far, nor does it necessarily have the same number of characters. Such an embodiment may further include providing to the user the plurality of names that share that common prefix, and, in response to a second user action, selecting one of the hypotheses as representing the intended user input. Such an embodiment may further include providing for each name matching hypotheses to the user an indication of which character(s) should be spelled out next to further favor that particular hypothesis.

In further embodiments of either of the above, one of the user actions may be a correction command to undo the last user action. If such correction command is issued after a user action that consists of a short pause made after spelling out one or more characters, it has as the effect to undo the effect of that last user action and of the spelled characters that were spoken between the previous user action and this last user action.

Some subset of the provided characters may be collected from the user via a touch-based interface instead of from an automatic speech recognition interface. In such embodiments, the first user action can be releasing the interface during a short time.

In some embodiments, the allowable recognition hypotheses represent place names for a navigation system such as city names and/or street names.

Embodiments of the present invention also include a device adapted to use any of the foregoing methods. For example, the device may be a navigation system such as for an automobile.

### BRIEF DESCRIPTION OF THE DRAWINGS

FIG. 1 shows a typical speech recognition engine according to the prior art.

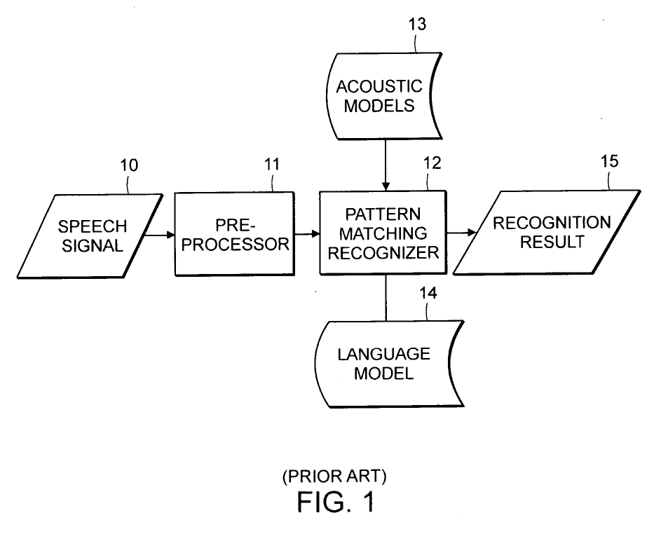

FIG. 2 shows a typical speech recognition engine in combination with a spelling matcher according to prior art. This configuration also corresponds with an embodiment of the present invention.

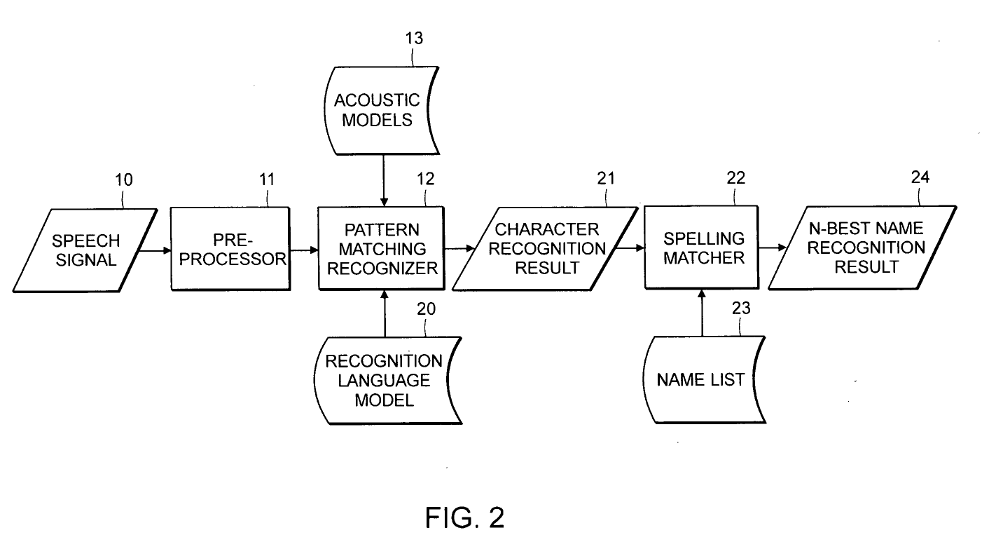

### DETAILED DESCRIPTION OF SPECIFIC EMBODIMENTS

Various embodiments of the present invention are directed to user interfaces for speech recognition using incremental partial spelling of names with spoken input characters and corresponding visual and/or spoken feedback to the user. Embodiments of the present invention can be used in both embedded and network (distributed multi-modal) ASR projects, including, but not limited to, directory assistance, destination entry and name dialing.

In some specific embodiments, input characters may also be provided via an alternative touch-based interface such as a tumbling wheel, a key press, or a touch-screen. Characters entered with such an alternative interface may be intermixed with spoken input characters, but in contrast to the uncertainty associated with the recognition of spoken input characters, the characters from the alternative interface may be treated as having absolute certainty.

In some further embodiments, a sequence of input characters from the alternative interface may be considered as a separate block of characters. For example, if a character is selected by pressing a key or by touching a character on a touch screen, each such character may be considered as a character block of a single character that has been recognized with absolute certainty (so the spell matching module gets an input character recognition result that contains only that character and all other characters have zero probability). In other embodiments, the alternative interface may use optical character recognition technology for isolated characters that are written on a touch screen, where each character is considered as a character block consisting of a single character, but with non-zero probabilities for some alternative characters. In still other embodiments, some characters may be recognized with optical character recognition technology for continuous written text, in which case, character blocks originating from the touch-based interface may contain several characters and alternatives for each (e.g. in a lattice representation), which may all be presented to the spelling matcher. A unifying way of describing these different manners of splitting the touch-based input in character blocks is by saying that the end of a block is marked each time the touch-based interface is “released” longer than a certain time (typically a very short time), for example: after every key stroke, after lifting the pen or finger after writing a single character or a sequence of characters as continuous text.

In response to a string of input characters from a user, the system displays an N-best list of possible recognition hypotheses. The N-best list can contain both complete names and, in some embodiments, also common prefixes of several names. For example, take the case of a system that matches a name list against a certain character recognition result after the user uttered some characters (e.g. “BOS”). The name matching algorithm may hypothesize a given prefix of some names (e.g. “DOS”) with a specific likelihood, (taking into account deletion, insertion and substitution probabilities, and influenced by possible recognition mistakes of the recognition engine). If that likelihood is high enough, the associated prefix will have an entry in the N-best list. If there is only one name that starts with that prefix, the N-best list will have an entry with the entire name instead. The N-best list may only show an entry with the prefix, possibly augmented with the number of names that share that prefix (e.g. DOS . . . (5)). If there are several names that start with that prefix, but if all such names have a longer common prefix, the N-best list may only show the longest common prefix (e.g. DOSAR . . . (5)). In that case, the representation of the N-best list on screen may also indicate where the user is supposed to continue spelling by marking either the already recognized characters or the next to-be-spelled character(s) differently, for example by using bold characters, or by underlining characters, etc. (e.g. DOSAR . . . (5)).

The fact that the characters are spoken introduces an uncertainty on the recognized characters (this in contrast to characters that are entered with most touch-based interfaces). As a consequence, the N-best list can be a mixture of names and prefixes of names with different starting letters. For example, the N-best list may contain at the same time entries such as BOS . . . (2), DOSAR . . . (5) and BOZ . . . (4). In some embodiments it may even contain at the same time the entry BO . . . (6).

If the list of complete names and common prefixes that have a high enough likelihood to be worth showing is smaller than the number of entries that can be shown on the screen, some of the common prefixes may be expanded into their complete names and these can be shown on screen instead (e.g. if the only common prefix with sufficiently high likelihood is BOSTO . . . (2), and if 3 entries can be shown on screen, the N-best list may immediately show the two expansions (e.g. BOSTON and BOSTOK), instead of the common prefix.

In response to the N-best list that is shown, the user can select one of the entries, for example, by saying “line 2” in order to select the second entry, or by pushing a button. In some embodiments, the user can also continue spelling. If the user selects an entry from the N-best list with a certain common prefix (e.g. the line with DOSAR . . . (5)), a new N-best list is shown on screen with the list of common prefixes of names (and possibly complete names) that start with that certain common prefix. That new N-best list is the list of best matching names (and prefixes of names), given that specific common prefix. In the example above, this is the N-best list of names and prefixes of names that start with “DOSAR.”

In response to the new N-best list, the user can again select one of the entries. In some embodiments he can again spell out some more characters. If he spells out more characters after a selection of a line, the prefix that has been confirmed by the line selection remains assumed to be recognized with absolute certainty, whereas the additional spelled out characters have the usual uncertainty as reflected by the character recognition result and possible deletion, insertion and substitution probabilities that are taken into account by the spelling matcher.

A short pause between spoken letters can cause an update of the N-best list on the screen, whereas a long pause can act as a selection of the first line of the N-best list. If the user pauses briefly (longer than some time, Tₛₕₒᵣₜ, e.g. 300 milliseconds) after spelling out one or more characters of a name, an N-best list of best matching names and/or common prefixes of names is displayed on the screen. The user can simply continue spelling out more characters, or can select an entry from the N-best list on the screen (e.g. by saying “line 2” or “number 2”, or by pushing a button). If the user continues spelling, the N-best list on the screen is updated after every short pause. If the user selects an entry from the N-best list on the screen, the system assumes that the corresponding name has been recognized (and if that is a complete name, it may ask with speech output for an explicit or implicit confirmation).

If the user makes a long pause (longer than T_{long}, e.g. 3 seconds) or gives a stop spelling-command (e.g. the word “stop”) after spelling out one or more characters, the system assumes that the top ranking (i.e. the best matching) entry from the N-best list has been recognized. In some embodiments, it will respond to this in exactly the same way as if the first entry was selected with an explicit selection command (e.g. “line 1”). That is, if the top ranking entry is a single full name, it may ask with speech output for an explicit or implicit confirmation, and if it is a prefix (note that the prefix may itself be a full name, but at the same time also the prefix of another name), it creates a new N-best list, assuming that that prefix has been confirmed.

In other embodiments, the system will respond differently when the top-ranking hypothesis in the N-best list is a prefix. It may spell out the characters of the prefix (e.g. with a text to speech system) and ask the user to continue spelling. Or (typically if the number of names that share that prefix is small) the system may give audio feedback about that small set of names and ask the user to select. Another option is (typically if the prefix itself is a full name, but if the number of names with that prefix is still to large) that the system may ask the user whether the name that corresponds with the prefix is the desired name, and if the answer is negative, ask the user to continue spelling, possibly after having spelled out the characters of the prefix.

In some embodiments, a show results command is an alternative for the short pause and also causes an update of the N-best list on the screen. In yet other embodiments, the show results command replaces the short pause and no distinction between short or long pauses is made.

In further embodiments, the user interface for incremental partial spelling as described above may also support a correction command (e.g. “correct that” or “back” or “go back”), after which the last command is undone and the system reverts to the state prior to the issuing of that last command. That last command can be the selection of an entry from the N-best list, or the selection of the top ranking hypothesis after a long pause. That last command can also be the last block of spelled characters (every pause longer than Tₛₕₒᵣₜ marks the end of a block of spelled characters).

In some embodiments, the screen only shows a single entry (so the special case of an N-best list with N=1). In one such embodiment, that single entry shows after every short pause the best matching name so far, or, as long as there is more than one name with the same hypothesized best matching prefix, the longest common prefix of those names, possibly augmented with the number of names that share that prefix. In one such embodiment, the user can issue the correction command to undo the effect of the last block of spelled out characters. A stop spelling command can also be input to confirm that the shown name is the correct one. A long pause acts as an equivalent of the stop spelling command. If at the moment of such confirmation the shown entry is still a prefix (i.e. there is more than one name that starts with that prefix), the system may prompt the user to continue spelling, or (typically if the number of names that matches the prefix is small and/or if one of such names coincides with the prefix itself) to select from the list of names that matches the prefix and is prompted (for example with speech synthesis) to the user at that moment. The user can also interrupt that prompting by issuing a continue spelling command (for example, after pushing a barge-in button). In one further embodiment, the user can also issue a play list command to force the prompting of the list of best matching names or prefixes of names instead of continuing spelling.

In some embodiments, there is no visual feedback. In that case, the user interface is adapted to give faster spoken feedback to the user. In one such embodiment, intermediate character recognition results are still presented to the spelling matcher after each short pause, but no feedback about the name matching result is given to the user on such event (this is performed just as a means to do some spelling matching processing while the user may still be speaking and in this way improve the response time). The long pause is typically shortened, for example, to two seconds. The user can also issue a stop spelling command as a faster alternative for the long pause. After the long pause or stop spelling command, feedback is given to the user about the name matching results so far. If there is a small set of top matching full names with high likelihood, the system will prompt to user to select one of these or to issue the continue spelling command, possibly after pushing the barge-in button. If the top-matching hypothesis is a prefix of many names and none of these names corresponds with the prefix itself, the system will spell out the prefix, and ask the user to continue spelling. The user can also issue a correct that-command that will undo the effect of the last block of spelled characters, but in this case, only the previous long pauses and stop spelling commands mark the end of a block of characters, not the short pauses.

In some specific embodiments, the system is used in a car to enter the names of destinations into a navigation system, for example, city names and/or street names. In some specific embodiments of this, the system may use visual feedback with one or more lines when the car is standing still, but the screen feedback is disabled when the car is driving. In such embodiments, the spelling user-interface may be swapped between the methods described above depending on the driving speed.

Embodiments of the invention may be implemented in any conventional computer programming language. For example, preferred embodiments may be implemented in a procedural programming language (e.g., “C”) or an object oriented programming language (e.g., “C++”). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention. One such modification is to allow the speaker to start spelling a name in the middle of the name (e.g., at the start of the second word of that name) instead at the very first character of the name.

What is claimed is:

1. A method of speech recognition processing comprising:
collecting with a speech recognition process a plurality of characters representative of an initial portion of an intended user input;
in response to a short pause in the user input, visually providing to the user at least one name matching hypothesis predicted to correspond to the intended user input; and
recognizing a user selection of a name matching hypothesis as representing the intended user input.

2. A method according to claim 1, wherein after providing to the user at least one name matching hypothesis, additional letters representative of the initial portion of the intended user input are provided until another short pause in the user input when the response is repeated.

3. A method according to claim 1, wherein the user selection includes one of a long pause, a stop spelling command, and a line selection command.

4. A method according to claim 1, wherein the name matching hypotheses represent place names for a navigation system.

5. A device utilizing speech recognition, the device comprising:
means for collecting with a speech recognition process a plurality of characters representative of an initial portion of an intended user input;
means for, in response to a short pause in the user input, visually providing to the user at least one name matching hypothesis predicted to correspond to the intended user input; and
means for recognizing a user selection of a name matching hypothesis as representing the intended user input.

6. A device according to claim 5, wherein the means for visually providing to the user at least one name matching hypothesis, includes means for the user to continue providing additional letters representative of the initial portion of the intended user input until another short pause in the user input when the means for visually providing is repeated.

7. A device according to claim 5, wherein the user selection includes one of a long pause, a stop spelling command, and a line selection command.

8. A device according to claim 5, wherein the device is a navigation system.

9. A device according to claim 8, wherein the navigation system is use for an automobile.

10. A method of speech recognition processing comprising:
collecting with a speech recognition process a plurality of characters representative of an initial portion of an intended user input; and
in response to a first user action, determining at least one name matching hypothesis predicted to correspond to the intended user input;
wherein the at least one name matching hypothesis can be a common prefix shared by a plurality of names.

11. A method according to claim 10, further comprising:
providing to the user the plurality of names that share the common prefix.

12. A method according to claim 10, further comprising:
providing to the user an indication of the number of names that share the common prefix.

13. A method according to claim 10, further comprising:
providing to the user a set of related prefixes that share the common prefix.

14. A method according to claim 10, further comprising:
in response to a second user action, selecting one of the name matching hypotheses as representing the intended user input.

15. A method according to claim 14, further comprising:
in response to selection of a name matching hypothesis that is a common prefix, providing to the user the plurality of names that share the common prefix.

16. A method according to claim 14, further comprising:
in response to selection of a name matching hypothesis that is a common prefix, providing to the user a set of common prefixes that share the common prefix.

17. A method according to claim 14, further comprising:
in response to selection of a name matching hypothesis that is a common prefix, repeating the method considering only hypotheses that start with the common prefix.

18. A method according to claim 10, wherein after providing to the user at least one name matching hypothesis, additional characters representative of the initial portion of the intended user input are provided until the first user action and response is repeated.

19. A method according to claim 10, wherein the recognition hypotheses names represent place names for a navigation system.
